(19) United States
(12) Patent Application Publication
(10) Pub. No.: US 2005/0052537 A1
(43) Pub. Date: Mar. 10, 2005

(54) Mounted imaging apparatus

(75) Inventor: Masayuki Mizusawa, Tokyo (JP)

Correspondence Address: PILLSBURY WINTHROP, LLP, P.O. BOX 10500, MCLEAN, VA, 22102, US

(73) Assignee: Olympus Corporation, Tokyo (JP)

(21) Appl. No.: 10/935,310

(22) Filed: Sep. 8, 2004

(30) Foreign Application Priority Data
Sep. 9, 2003 (JP) 2003-316994

(51) Int. Cl. H04N 5/228

(52) U.S. Cl. 348/208.1

(57) ABSTRACT

A mounted imaging apparatus includes a goggles body and an imaging device fixed to the goggles body so that an object can be photographed in the same direction as the line of sight of a user, having a shutter button and a camera shake compensating mechanism.

### BACKGROUND OF THE INVENTION

1. Field of the Invention

This invention relates to a mounted imaging apparatus particularly fixed to the body of a photographer, using a small-sized digital camera,

2. Description of Related Art

Apparatuses for photographing objects to record their images, such as video cameras and digital cameras, are widely known. For example, in the digital camera, the object is photo-graphed by the procedure that the photographer holds the camera with his hands or a tripod, directs the camera toward the object, determines a photographic composition through a finder to push a shutter button with his finger or a release, and photographs and records the object.

In the conventional imaging apparatus mentioned above, however, the photographer must hold the camera with hands in photographing or fix it by the tripod. In addition, the line of sight of the photographer must be directed toward the object through the camera (finder). Thus, the photographer is difficult to perform other operations in photographing and also suffers inconvenience for carrying of the camera Moreover, since the camera must be positioned toward the object, a shutter chance may be missed by a slow positioning operation. Thus, the conventional imaging apparatus has the problem that the operation for recording the image is troublesome to the photographer.

As an imaging apparatus for solving this problem, an image recording apparatus set forth, for example, in Japanese Patent Kokai No. Hei 11-164186 is proposed.

As shown in FIG. 1, an image recording apparatus 50 set forth in Kokai No. Hei 11-164186 includes a photographic lens 51, an imaging means, a fixing means 53, detection means 54, 55, 56, and 57, and a camera body 58. Here, the imaging means is such as to image an object through the photographic lens and to convert an image of the object into an image signal. An imaging section 52 has the photographic lens 51 and the imaging means. The fixing means 53 is provided for the purpose of fixing the imaging section 52 to be mountable to, and dismountable from, the body of an photographer so that the photographic lens 51 is turned in the same direction as the face of the photographer. The detection means 54-57 are provided to be mountable to, and dismountable from, the body of the photographer, together with the fixing means 53. A voice made by the photographer or the movement of a predetermined part (for example, the muscle of his temple) excluding the body of the photographer is detected. The camera body 58 has the function of recording the image signal derived from the imaging means. An image is formed in accordance with the detection signal detected through the detection means 54-57. The image formed by the camera body 58 is displayed on an image display section 59.

According to the image recording apparatus 50 of Kokai No. Hei 11-164186, the imaging section 52 is fixed to the body of the photographer through the fixing means 53 so that the photographic lens 51 is turned in the same direction as the face of the photographer. The photographer's intention is detected by the movement of the body of the photographer excluding his hands or by the photographer's voice to control the record of the image derived from the imaging means in accordance with the detection signal. By doing so, the photographer is capable of photographing the object without using his hands. Furthermore, the photographic lens is always turned in the same direction as the face of the photographer and thereby the troublesome operation that the camera must be positioned toward the object can be obviated so that the shutter chance is not missed.

### SUMMARY OF THE INVENTION

The mounted imaging apparatus according to the present invention includes a goggles body and an imaging device fixed to the goggles body so that an object can be photographed in the same direction as the line of sight of a user, having a shutter button and a camera shake compensating mechanism.

In the mounted imaging apparatus according to the present invention, the camera shake compensating mechanism is constructed with a control means controlled so that when the shutter button is pushed, a shutter is operated in about 0.1-1 sec after the release of a finger from the shutter button, and image information of the object imaged during the shutter operation is stored in a recording medium.

In the mounted imaging apparatus according to the present invention, the camera shake compensating mechanism includes two shutter buttons arranged so that they can be pushed from both sides with fingers of one hand and a control means controlled so that when forces of the fingers pushing the two shutter buttons are balanced, the shutter is operated and image information of the object imaged during the shutter operation is stored in a recording medium.

In the mounted imaging apparatus according to the present invention, the camera shake compensating mechanism includes a photosensor and a control means controlled so that when detection light in the photosensor is intercepted, the shutter is operated and image information of the object imaged during the shutter operation is stored in a recording medium.

These and other features and advantages of the present invention will become apparent from the following detailed description of the preferred embodiments when taken in conjunction with the accompanying drawings.

### BRIEF DESCRIPTION OF THE DRAWINGS

FIG. 1 is a view showing schematically a conventional mounted image recording apparatus;

FIG. 2 is a perspective appearance view showing schematically a mounted imaging apparatus of each of the embodiments in the present invention;

FIG. 3 is a block diagram showing schematically the interiors of an imaging device and an image display device in the mounted imaging apparatus of FIG. 2;

FIG. 4 is a view showing schematically a camera shake compensating mechanism of the mounted imaging apparatus of a first embodiment in the present invention;

FIG. 5 is a view showing schematically a camera shake compensating mechanism of the mounted imaging apparatus of a second embodiment in the present invention;

FIG. 6 is a view showing schematically a camera shake compensating mechanism of the mounted imaging apparatus of a third embodiment in the present invention;

FIG. 7 is a view showing schematically a camera shake compensating mechanism of the mounted imaging apparatus of a fourth embodiment in the present invention; and

FIG. 8 is a view showing schematically a camera shake compensating mechanism of the mounted imaging apparatus of a fifth embodiment in the present invention.

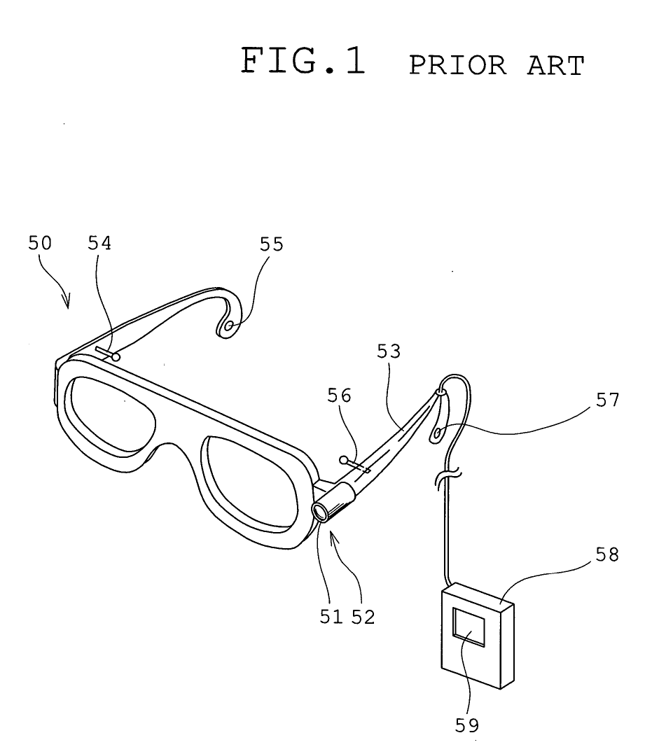

### DETAILED DESCRIPTION OF THE PREFERRED EMBODIMENTS

Before undertaking the description of the embodiments, the function and effect of the present invention will be explained below.

An imaging unit to which the mounted imaging apparatus of the present invention is applied separately includes an imaging device and an image display device.

The imaging device has a photographic lens, a conversion means, and a recording means recording an image signal. Here, the conversion means is such as to image the object through the photographic lens and to convert an image of the object into an image signal. The image display device has an image display section reproducing a received image signal as an image. To receive the image signal derived from the imaging device, a cable or a cord, or radio communication utilizing electric waves is used.

Here, in the mounted imaging apparatus according to the present invention, the imaging device is constructed so that the photographic lens is turned in the same direction as the face (the line of sight) of a photographer (for example, a goggles wearer) and is provided to be mountable to, and dismountable from, the fixing means of goggles. In addition, the imaging device has a shutter button and a camera shake compensating mechanism.

When the imaging device, like the present invention, is fixed in the proximity of the face of the photographer so that the photographic lens is turned in the same direction as the face (the line of sight) of the photographer, the number of degrees of hand freedom of the photographer can be increased. Consequently, the troublesome operation like the conventional imaging apparatus that the camera must be positioned in photographing can be obviated.

In the mounted imaging apparatus according to the present invention, the shutter button is provided for manual shutter operation. Whereby, the recording indication of a photographed image is detected by using the photographer's hand, and a recording operation is controlled in accordance with a detection signal. A photosensor and a piezoelectric element are used as the detection means so that compactness of the entire apparatus is achieved. By doing so, the photographer uses his hand and is capable of securely photographing the object without any operation error. The photographer's intention can be clarified by the manual operation, which also contributes to the prevention of a snapshot taken stealthily. Furthermore, in the present invention, the imaging apparatus can also be designed so that when the shutter is operated or when the image information of the object imaged during the shutter operation is stored in the recording medium, a shutter noise is produced. By doing so, it becomes easy to recognize the achievement of the photographing operation, and the function of preventing the snapshot taken stealthily can be further improved.

When the camera shake compensating mechanism is provided like the mounted imaging apparatus of the present invention, the camera shake caused when photographing is performed can be eliminated. As mentioned above, the imaging device is always turned in the same direction as the face of the photographer, and thus the troublesome operation that the camera must be positioned toward the object can be obviated so that the shutter chance is little missed. It is desirable that the imaging device captures an object nearly equivalent to the line of sight of the photographer. It is also desirable that the imaging device is fixed in the proximity of the side of a part corresponding to a frame of spectacles in the goggles body. By doing so, impulse or interference can be avoided.

In the mounted imaging apparatus according to the present invention, it is desirable that the camera shake compensating mechanism is constructed with a control means controlled so that, for example, when the shutter button is pushed, the shutter is operated in about 0.1-1 sec after the release of a finger from the shutter button and image information of the object imaged during the shutter operation is stored in a recording medium.

The camera shake compensating mechanism may include two shutter buttons arranged so that they can be pushed from both sides with fingers of one hand and a control means controlled so that when forces of the fingers pushing the two shutter buttons are balanced, the shutter is operated and image information of the object imaged during the shutter operation is stored in a recording medium.

The camera shake compensating mechanism may include a photosensor and a control means controlled so that when detection light in the photosensor is intercepted, the shutter is operated and image information of the object imaged during the shutter operation is stored in a recording medium.

The camera shake compensating mechanism may be constructed so that the shutter button is connected by a cord with the body of the imaging device; when the shutter button is pushed, the shutter is operated without exerting the force of the finger pushing the button on the body of the imaging device; and a signal for storing the image information of the object imaged during the shutter operation in a recording medium is transmitted to the body of the imaging device.

The camera shake compensating mechanism may be constructed so that the shutter button is connected to the top of a short spring-like cord extending from the body of the imaging device, and when the shutter button is pushed, the force of the finger pressing the button is not exerted on the body of the imaging device through the cord.

The camera shake compensating mechanism may be constructed so that the shutter button is connected to the top of a short string-like cord extending from the body of the imaging device, and when the shutter button is pushed, the force of the finger pressing the button is not exerted on the body of the imaging device through the cord.

The camera shake compensating mechanism may be constructed so that the shutter button is provided independently of the body of the imaging device and is connected by wireless thereto, and when the shutter button is pushed, the shutter is operated and a signal for storing the image information of the object imaged during the shutter operation in a recording medium is transmitted to the body of the imaging device.

In the mounted imaging apparatus according to the present invention, it is desirable that the imaging device is constructed as a unit that is mountable to, and dismounted from, a place corresponding to a frame of spectacles in the goggles body.

In the mounted imaging apparatus according to the present invention, it is favorable to have a waterproof function.

In the mounted imaging apparatus according to the present invention, it is desirable that an area corresponding to the field angle of the imaging device is previously marked at a place corresponding to a lens section of spectacles in the goggles body.

In accordance with the drawings, the preferred embodiments of the mounted imaging apparatus of the present invention will be explained below.

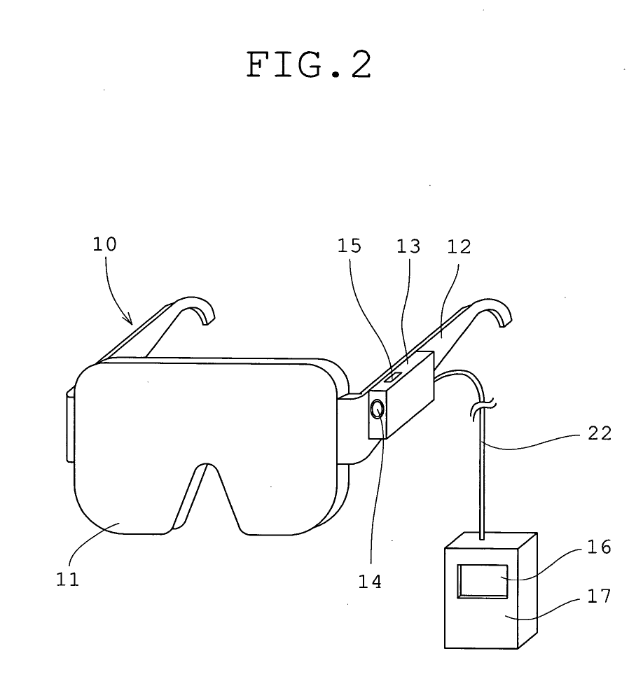

FIG. 2 shows schematically the mounted imaging apparatus of each of the embodiments in the present invention.

In a mounted imaging apparatus 10 of the present invention, an imaging device 13 is constructed as an aspect of a digital still camera electronically recording a still image and is fixed to a frame 12 of spectacles in the goggles body.

The imaging device 13 has a photographic lens 14 in its body. Behind the photographic lens 14, a CCD (not shown in FIG. 2) corresponding to an image sensor and a recording section (not shown) recording image information imaged by the CCD are arranged. Also, although a specific configuration of the photographic lens 14 is not illustrated in the figure, any configuration that the image of the object is formed on the imaging surface of the image sensor is satisfactory and a known lens configuration may be used. In FIG. 2, reference numeral 11 denotes a lens section in the goggles body and 15 denotes a shutter button.

The imaging device 13 is mounted to the right side of the frame 12 so that the optical axis of the photographic lens 14 is directed in the same direction as the line of sight of an photographer. The imaging device 13 is provided with a setting angle adjusting mechanism (not shown) in which a setting angle in the frame 12 can be fine adjusted.

The place where the imaging device 13 is mounted and fixed is not limited to the right side of the frame 12 of spectacles, shown in FIG. 2, in the goggles body. Specifically, when the photographer mounts the goggles body on his head, the imaging device may be mounted and fixed at any place where the photographic lens 14 can be directed in the same direction as the line of sight of the photographer, for example, to the left side of the frame 12 or a portion above the middle of the front surface of the frame 12.

Electric signal wires connected to the imaging device 13 and light-emitting diodes, although not shown, may be embedded inside the frame 12 so that information on a residual battery capacity of the imaging device 13 and on the number of photographed images is indicated by the degree of light of the light-emitting diodes.

An image display device 17 has an image display section 16 such as a liquid crystal display (LCD). The image display section 16 is designed to display an image photographed through the imaging device 13 and transmitted through a cable or a cord 22, or the electric wave.

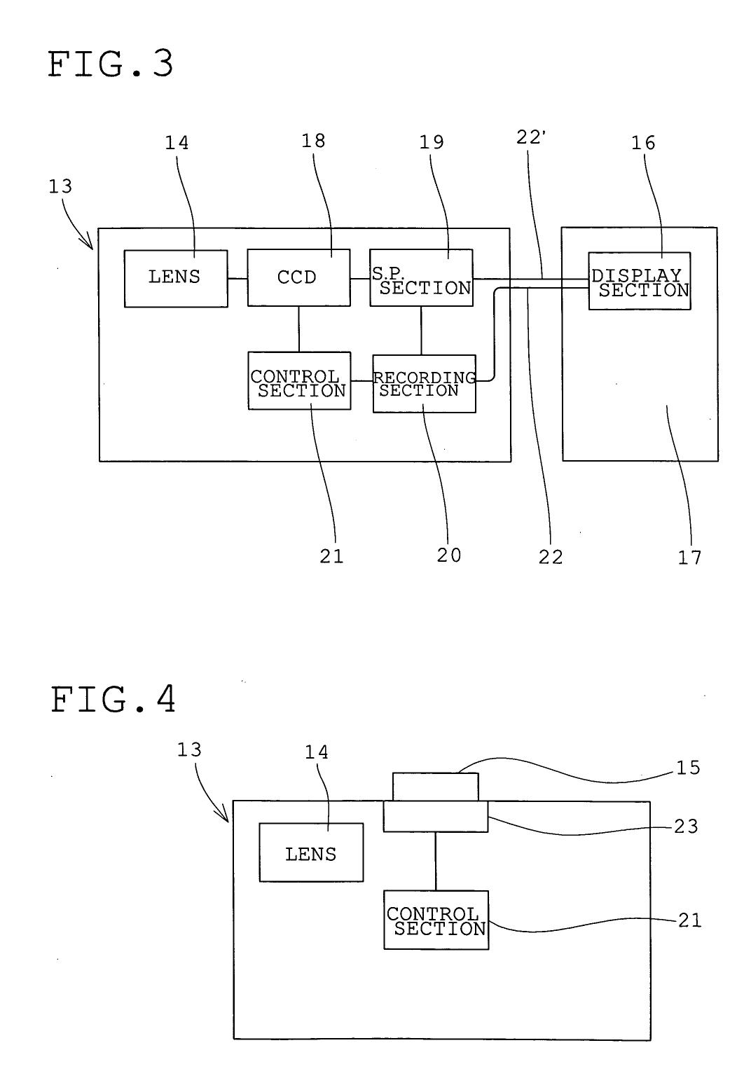

FIG. 3 shows schematically the interiors of the imaging device and the image display device in the mounted imaging apparatus of FIG. 2.

The imaging device 13 includes the photographic lens 14, a CCD (an image sensor) 18, a signal processing section 19, a recording section 20, a control section 21, and the image display section 16. The signal processing section 19 is constructed with generally known circuits such as an analog processing circuit, an A/D converter, and a digital image processing circuit. The image display section 16 is provided in the image display device 17.

In the imaging apparatus of the present invention constructed as mentioned above, the image of the object formed on the light-receiving surface of the CCD 18 through the photographic lens 14 is photoelectrically converted through the CCD 18 and is read out in turn as an image signal.

Is The image signal read out from the CCD 18 is properly signal-processed by the signal processing section 19. Where a signal of an image record indication is sent by the shutter operation, the image is stored in a recording section 20 such as a housed memory (for example, a flash memory housed in the camera) or a mountable and dismountable external memory card. The image signals read out from the CCD 18 and the recording section 20 are signal-processed by the signal processing section 19. Subsequently, each of the image signals is introduced into the image display device 17 and the photographed image is displayed on the image display section 16.

The image displayed on the image display section 16 is not limited to the still image photographed (recorded in the recording section 20) by the shutter operation (photographing operation). Moreover, when the image display section 16 is designed so that it can be communicated with the imaging device 13 by the cable or the cord 22, or the electric wave, an image before the shutter operation (a moving image or intermittent image) can also be displayed.

The imaging device 13 has an automatic exposure (AE) adjusting function and an auto-focus (AF) function which are well known (not shown). Thus, when the photographic lens 14 is directed toward the object, optimum exposure adjustment and focusing can be automatically performed. The control section 21 is constructed to generalize and control individual circuits of the mounted imaging apparatus 10. The ON-OFF operation of the shutter button which signifies the photographic intention of the photographer is such that the pressure of the finger is converted by a piezoelectric element into an electric signal, which is transmitted to the control section 21.

In the present invention, the camera shake compensating mechanism is constructed so that after the shutter button is pushed, the shutter is operated and the image information of the object imaged during the shutter operation is stored in the recording medium. Examples of specific structures in the camera shake compensating mechanism will be described below.

FIGS. 4-7 show the embodiments of shutter structures, each having the camera shake compensating mechanism. In the present invention, in order to prevent the snapshot taken stealthily, it is further desirable that the shutter is constructed so that when the shutter operation is completed, an effective noise is produced.

### First Embodiment

FIG. 4 shows the camera shake compensating mechanism of the mounted imaging apparatus of the first embodiment in the present invention.

In the camera shake compensating mechanism of the first embodiment, when the photographer pushes the shutter button 15, a piezoelectric element 23 converts the pressure of the finger into an electric signal, which is transmitted to the control section 21. Here, in order to prevent the camera shake, the control section 21 is constructed so that the shutter is operated in about 0.1-1 sec after the release of the finger from the shutter button 15, and image information of the object imaged during the shutter operation is stored in the recording section (not shown).

If the shutter is operated in less than 0.1 sec after the release of the finger from the shutter button 15, the pressure of the finger still remains in the frame and the camera shake may be caused. On the other hand, if the shutter is operated in more than 1 sec after the release of the finger from the shutter button 15, the photographic composition of the photographer's intention may be changed.

It is thus desirable that a time difference between the release of the finger from the shutter button 15 and the store of the image information of the object imaged during the shutter operation in the recording section (not shown) is 0.1-1 sec.

### Second Embodiment

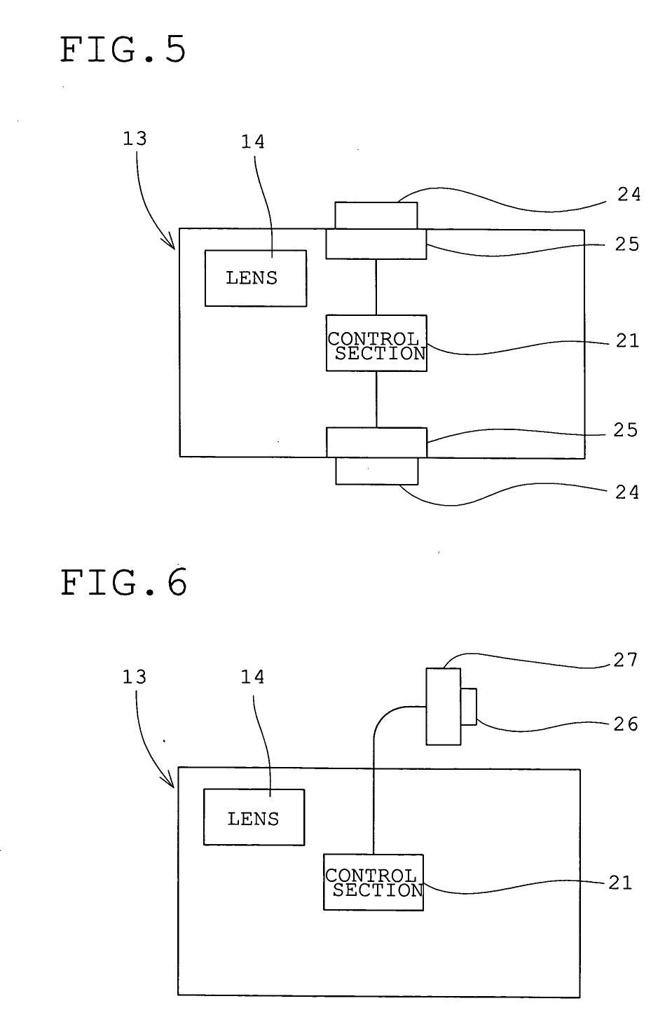

FIG. 5 shows the camera shake compensating mechanism of the mounted imaging apparatus of the second embodiment in the present invention.

The camera shake compensating mechanism of the second embodiment is provided with two shutter buttons 24 arranged so that they can be pushed from both sides with fingers of one hand. Specifically, this mechanism is such that the photographer is capable of pushing the two shutter buttons 24 at the same time from opposite directions. The control section 21 is constructed so that when forces of the fingers pushing the two shutter buttons 24 are balanced, the shutter is operated and image information of the object imaged during the shutter operation is stored in the recording section (not shown).

According to the camera shake compensating mechanism of the second embodiment, the magnitudes and directions of forces experienced by the shutter buttons 24 pushed from both sides are detected by piezoelectric elements 25 provided on both sides. In this case, when the forces from both sides are the same, the synthetic vector sum becomes nearly zero. In this state, the forces are balanced and thus the shutter is operated without any camera shake.

### Third Embodiment

FIG. 6 shows the camera shake compensating mechanism of the mounted imaging apparatus of the third embodiment in the present invention.

In the camera shake compensating mechanism of the third embodiment, a shutter button 26 is connected with the imaging device 13 by a cord-like matter. Thus, a signal produced when the photographer pushes the shutter button 26 is transmitted as the electric signal to the control section 21 by a piezoelectric element 27. In this case, the camera shake compensating mechanism is such that the force of the finger pushing the shutter button 26 is not exerted on the body of the imaging device 13.

Also, it is desirable that the camera shake compensating mechanism is constructed so that the shutter button 26 is connected to the top of a short string- or spring-like cord extending from the body of the imaging device 13, and when the shutter button 26 is pushed, the force of the finger pushing the button is not exerted on the body of the imaging device 13 through the cord.

### Fourth Embodiment

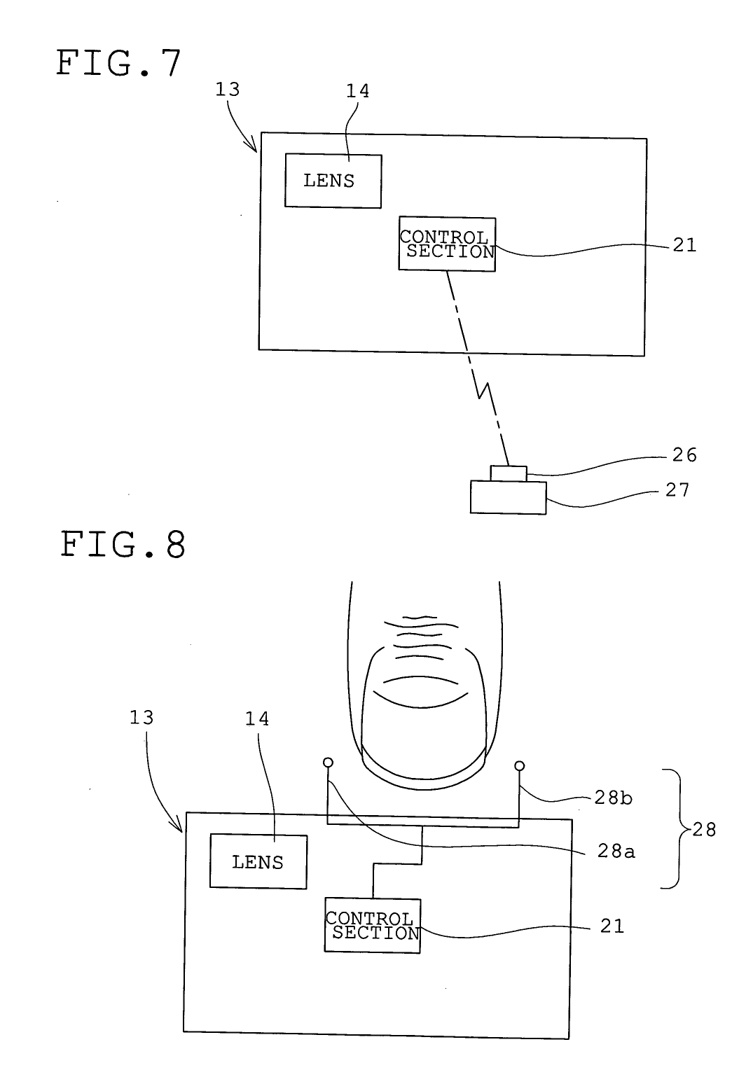

FIG. 7 shows the camera shake compensating mechanism of the mounted imaging apparatus of the fourth embodiment in the present invention.

The camera shake compensating mechanism of the fourth embodiment is constructed so that the shutter button 26 is connected by wireless to the imaging device 13 and a signal produced when the photographer pushes the shutter button 26 is transmitted as the electric wave to the control section 21. In the fourth embodiment, when the shutter button 26 is pushed, the finger does not touch the imaging device 13 and therefore there is no fear of the camera shake.

### Fifth Embodiment

FIG. 8 shows the camera shake compensating mechanism of the mounted imaging apparatus of the fifth embodiment in the present invention.

The camera shake compensating mechanism of the fifth embodiment provides the imaging device 13 with a photosensor 28 including a light-emitting sensor 28a and a light-receiving sensor 28b arranged opposite to each other at a preset distance away. When a finger is put between the light-emitting sensor 28a and the light-receiving sensor 28b to intercept detection light between the sensors, a signal produced at this time is transmitted to the control section 21 and the shutter is operated so that the image information of the object imaged during the shutter operation is stored in the recording medium. In the fifth embodiment, when the shutter is operated, the finger does not touch the imaging device 13 and therefore there is no fear of the camera shake.

Thus, according to the mounted imaging apparatus of each of the above embodiments, even when the photographer operates the shutter with his hand to photograph, an image free from camera shake can be recorded by virtue of the camera shake compensating mechanism.

Also, although in each embodiment the example where the digital still camera is used as the imaging device is cited, the mounted imaging apparatus of the present invention is capable of applying a camera (video camera) for storing a moving image in the recording medium such as a video tape, not to speak of the camera for recording the still image.

In the mounted imaging apparatus of each embodiment, it is desirable that the imaging device 13 is constructed as a unit that is mountable to, and dismountable from, a place corresponding to the frame 12 of spectacles in the goggles body. By doing so, existing goggles can be utilized.

In the mounted imaging apparatus of each embodiment, it is favorable to have a waterproof function. By doing so, the imaging apparatus is applicable to scuba diving.

In the mounted imaging apparatus of each embodiment, it is desirable that an area corresponding to the field angle of the imaging device 13 is previously marked at a place corresponding to a lens section 11 of spectacles in the goggles body shown in FIG. 2. By doing so, a photographing area can be definitely determined and it becomes easy to photograph.

1. A mounted imaging apparatus comprising:
a goggles body; and
an imaging device fixed to the goggles body so that an object can be photographed in the same direction as a line of sight of a wearer of the goggles body, having a shutter button and a camera shake compensating mechanism.

2. A mounted imaging apparatus according to claim 1, wherein the camera shake compensating mechanism is constructed with a control means controlled so that when the shutter button is pushed, a shutter is operated in about 0.1-1 sec after a release of a finger from the shutter button, and image information of the object imaged during a shutter operation is stored in a recording medium.

3. A mounted imaging apparatus according to claim 1, wherein the camera shake compensating mechanism includes two shutter buttons arranged so that the shutter buttons can be pushed from both sides with fingers of one hand and control means controlled so that when forces of the fingers pushing the two shutter buttons are balanced, a shutter is operated and image information of the object imaged during a shutter operation is stored in a recording medium.

4. A mounted imaging apparatus according to claim 1, wherein the camera shake compensating mechanism includes a photosensor and a control means controlled so that when detection light in the photosensor is intercepted, a shutter is operated and image information of the object imaged during a shutter operation is stored in a recording medium.

5. A mounted imaging apparatus according to claim 1, wherein the camera shake compensating mechanism is constructed so that the shutter button is connected by a cord with a body of the imaging device; when the shutter button is pushed, a shutter is operated without exerting a force of a finger pushing the button on the body of the imaging device; and a signal for storing image information of the object imaged during a shutter operation in a recording medium is transmitted to the body of the imaging device.

6. A mounted imaging apparatus according to claim 1, wherein the camera shake compensating mechanism is constructed so that the shutter button is connected to a top of a short spring-like cord extending from a body of the imaging device, and when the shutter button is pushed, a shutter is operated without exerting a force of a finger pushing the button on the body of the imaging device through the cord.

7. A mounted imaging apparatus according to claim 1, wherein the camera shake compensating mechanism is constructed so that the shutter button is connected to a top of a short string-like cord extending from a body of the imaging device, and when the shutter button is pushed, a shutter is operated without exerting a force of a finger pushing the button on the body of the imaging device through the cord.

8. A mounted imaging apparatus according to claim 1, wherein the camera shake compensating mechanism is constructed so that the shutter button is provided independently of a body of the imaging device and is connected by wireless thereto, and when the shutter button is pushed, a shutter is operated and a signal for storing image information of the object imaged during a shutter operation in a recording medium is transmitted to the body of the imaging device.

9. A mounted imaging apparatus according to claim 1, wherein the imaging device is constructed as a unit that is mountable to, and dismountable from, a place corresponding to a frame of spectacles in the goggles body.

10. A mounted imaging apparatus according to claim 1, having a waterproof function.

11. A mounted imaging apparatus according to claim 1, wherein an area corresponding to a field angle of the imaging device is previously marked at a place corresponding to a lens section of spectacles in the goggles body.

12. A mounted imaging apparatus according to claim 1, having an image display device displaying an image formed by the imaging device.
